(19) United States
(12) Patent Application Publication
(10) Pub. No.: US 2015/0289196 A1
(43) Pub. Date: Oct. 8, 2015

(54) Channel Access Avoiding Windows Having Restricted Access

(71) Applicant: Nokia Corporation, Espoo (FI)

(72) Inventor: Chittabrata Ghosh, Fremont, CA (US)

(73) Assignee: Nokia Corporation, Espoo (FI)

(21) Appl. No.: 14/247,441

(22) Filed: Apr. 8, 2014

(51) Int. Cl. H04W 48/08; H04W 88/08; H04W 84/12

(52) U.S. Cl. CPC H04W 48/08; H04W 84/12; H04W 88/08

(57) ABSTRACT

A method including receiving by an apparatus at least part of a first beacon, where the first beacon comprises information regarding at least a first periodic restricted access window (PRAW); and receiving by the apparatus at least part of a second beacon, where the second beacon comprises information regarding at least one restricted access window (RAW) and information on an access window that does not comprise a periodic restricted access window (PRAW) nor a non-periodic restricted access window (NRAW). The part of the second beacon received by the apparatus does not comprise complete information regarding a second periodic restricted access window (PRAW) of the second beacon.

### BACKGROUND

1. Technical Field

The exemplary and non-limiting embodiments relate generally to channel access and, more particularly, to channel access avoiding windows having restricted access.

2. Brief Description of Prior Developments

The following abbreviations that may be found in the specification and/or the drawing figures are defined as follows:
AP—Access point
eNB—evolved NodeB, such as in an evolved universal mobile telecommunication system (E-UMTS)
FCS—frame check sequence
IEEE—The Institute of Electrical and Electronics Engineers
MAC—Media Access Control
MCS—Modulation and Coding Scheme
NAV—Network Allocation Vector
NCE—Network Controller Element
PHY—physical layer
PPDU—PHY Protocol Data Unit
PSDU—Physical Layer Convergence Procedure (PLCP) Service Data Unit
RID—Response Indication Deferral
RRC—Radio Resource Control
STA—Station
TIM—Traffic Indication Map
TxOP—Transmit Opportunity
UE—User Equipment
WLAN—Wireless Local Area Network

IEEE 802.11 is a set of media access control (MAC) and physical layer (PHY) specifications for implementing wireless local area network (WLAN) communication. They are created and maintained by the IEEE LAN/MAN Standards Committee (IEEE 802). The standard and amendments provide the basis for wireless network products generally called Wi-Fi.

### SUMMARY

The following summary is merely intended to be exemplary. The summary is not intended to limit the scope of the claims.

In accordance with one aspect, an example method comprises receiving by an apparatus at least part of a first beacon, where the first beacon comprises information regarding at least a first periodic restricted access window (PRAW); and receiving by the apparatus at least part of a second beacon, where the second beacon comprises information regarding at least one restricted access window (RAW) and information on an access window that does not comprise a periodic restricted access window (PRAW) nor a non-periodic restricted access window (NRAW), where the part of the second beacon received by the apparatus does not comprise complete information regarding a second periodic restricted access window (PRAW) of the second beacon.

In accordance with another aspect, an example embodiment is provided in an apparatus comprising at least one processor; and at least one non-transitory memory including computer program code, the at least one memory and the computer program code configured to, with the at least one processor, cause the apparatus at least to receive at least part of a first beacon, where the first beacon comprises information regarding at least a first periodic restricted access window (PRAW); and receive at least part of a second beacon, where the second beacon comprises information regarding at least one restricted access window (RAW) and information on an access window that does not comprise a periodic restricted access window (PRAW) nor a non-periodic restricted access window (NRAW), where the part of the second beacon received by the apparatus does not comprise complete information regarding a second periodic restricted access window (PRAW) of the second beacon.

In accordance with another aspect, an example embodiment is provided in a non-transitory program storage device readable by a machine, tangibly embodying a program of instructions executable by the machine for performing operations, the operations comprising receiving by an apparatus at least part of a first beacon, where the first beacon comprises information regarding at least a first periodic restricted access window (PRAW); and receiving by the apparatus at least part of a second beacon, where the second beacon comprises information regarding at least one restricted access window (RAW) and information on an access window that does not comprise a periodic restricted access window (PRAW) nor a non-periodic restricted access window (NRAW), where the part of the second beacon received by the apparatus does not comprise complete information regarding a second periodic restricted access window (PRAW) of the second beacon.

In accordance with another aspect, an example method comprises transmitting by an apparatus a first beacon, where the first beacon comprises information regarding at least a first periodic restricted access window (PRAW); and transmitting by the apparatus a second beacon, where the second beacon comprises information regarding at least one restricted access window (RAW) and information on an access window that does not comprise a periodic restricted access window (PRAW) nor a non-periodic restricted access window (NRAW).

In accordance with another aspect, an example embodiment is provided in an apparatus comprises at least one processor; and at least one non-transitory memory including computer program code, the at least one memory and the computer program code configured to, with the at least one processor, cause the apparatus at least to transmit by the apparatus a first beacon, where the first beacon comprises information regarding at least a first periodic restricted access window (PRAW); and transmit by the apparatus a second beacon, where the second beacon comprises information regarding at least one restricted access window (RAW) and information on an access window that does not comprise a periodic restricted access window (PRAW) nor a non-periodic restricted access window (NRAW).

In accordance with another aspect, an example embodiment is provided in a non-transitory program storage device readable by a machine, tangibly embodying a program of instructions executable by the machine for performing operations, the operations comprising transmitting by the machine a first beacon, where the first beacon comprises information regarding at least a first periodic restricted access window (PRAW); and transmitting by the machine a second beacon, where the second beacon comprises information regarding at least one restricted access window (RAW) and information on an access window that does not comprise a periodic restricted access window (PRAW) nor a non-periodic restricted access window (NRAW).

### BRIEF DESCRIPTION OF THE DRAWINGS

The foregoing aspects and other features are explained in the following description, taken in connection with the accompanying drawings, wherein:

FIG. 1 is a diagram illustrating an example network;

FIG. 2 is a diagram illustrating some of the components of the devices shown in FIG. 1;

FIG. 3 is diagram illustrating examples of long beacons, short beacons and PRAW with an AP, a TIM STA (STA1) and a non-TIM STA (STA2);

FIG. 4 is diagram illustrating examples of long beacons, short beacons, NRAW and PRAW;

FIG. 5 is an example of a NRAW and a PRAW during an entire beacon period;

FIG. 6 is an example of no NRAW and no PRAW in a beacon period;

FIG. 7 is an example of a NRAW and PRAW in a beacon period with a leading non-RAW access period in front;

FIG. 8 is an example of a NRAW and PRAW in a beacon period with a trailing non-RAW access period;

FIG. 9 is an example of a short beacon;

FIG. 10 is a diagram illustrating an example method;

FIG. 11 is a diagram illustrating an example method; and

FIG. 12 is a diagram illustrating an example method.

### DETAILED DESCRIPTION OF EMBODIMENTS

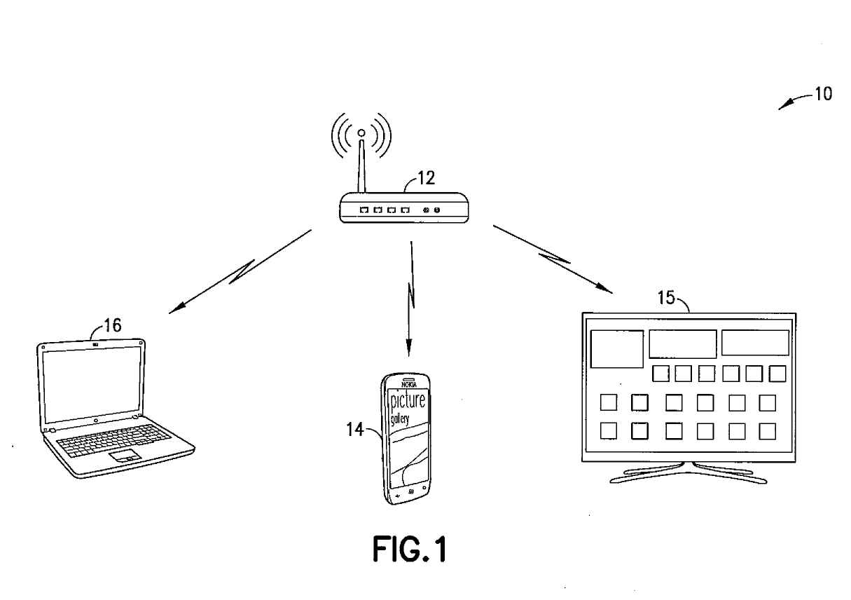

Referring to FIG. 1, a wireless communication system 10 is shown which incorporates features of example embodiments. Although the features will be described with reference to the example embodiments shown in the drawings, it should be understood that features can be embodied in many alternate forms of embodiments. The system 10 in this example is a wireless local area network (WLAN). However, features as described herein may be used with any suitable type of wireless communication system, such as 3GPP based technologies, other IEEE based technologies or the like.

In the example shown the system 10 includes an access node 12 and a plurality of devices 14, 15, 16 which may communicate wirelessly with the access node 12. The access node 12 may be an access point (AP), such as a wireless router for example, connected to the Internet (not shown) for example. The devices may comprise, for example, one or more smartphones 14, one or more network capable televisions 15, and/or one or more computers 16. These are merely examples of the devices. Any other suitable device may be connect to the wireless network including, for example, smart appliances, printers, home security devices, gaming systems, tablet computers, etc.

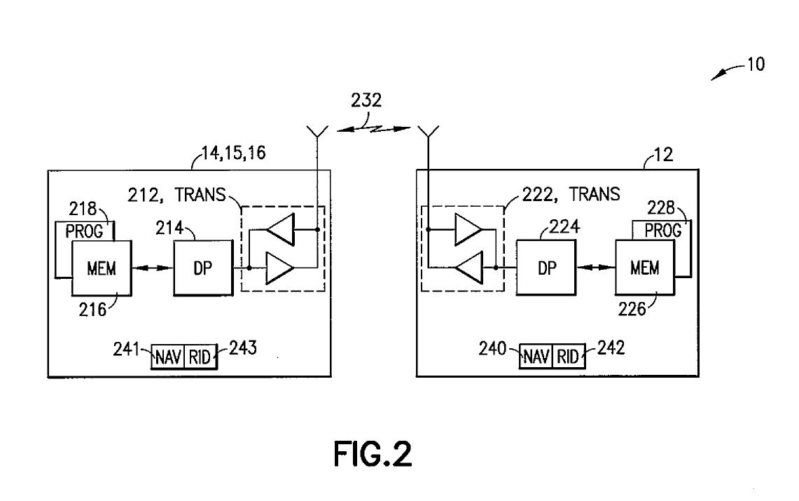

Referring also to FIG. 2, the wireless network 10 is adapted for communication over wireless links 232 between the access node 12 and the various devices 14, 15, 16. Features as described herein are not restricted to WLAN infrastructure basic service set (BSS). Features may be provided, for example, in an ad hoc network wherein the wireless links may be between two (non-AP) stations. Thus, according to an example embodiment, the access node 12 may be replaced by a station which is not an access node or an access point (AP). It may be, for example, a non-AP station for a wireless local area network.

Each of the devices 14, 15, 16 may be a station (STA) in the network 10. Each device 14, 15, 16 may include a controller, such as a computer or a data processor (DP) 214, and a computer-readable memory medium embodied as a memory (MEM) 216 that stores a program of computer instructions (PROG) 218. Each device 14, 15, 16 may also include a suitable wireless interface, such as radio frequency (RF) transceiver 212, for bidirectional wireless communications with the access node 12 via one or more antennas. Although features are being described herein with reference to the whole devices 12, 14, 15, 16, it should be noted that features as described herein may be provided in a subcomponent or assembly which is assembled into the devices 12, 14, 15, 16. For example, features by be provided in a chipset which is assembled into one or more of the devices 12, 14, 15, 16. The devices 12, 14, 15, 16 may, in some embodiments, also be referred to as a user equipment (UE).

The access node 12 also includes a controller, such as a computer or a data processor (DP) 224, a computer-readable memory medium embodied as a memory (MEM) 226 that stores a program of computer instructions (PROG) 228, and a suitable wireless interface, such as RF transceiver 222, for communication with the device 14, 15, 16 via one or more antennas. The access node 12 may be coupled via a data/control path to a NCE. The path may be implemented as an interface. The access node 12 may also be coupled to another access node via a data/control path, which may be implemented as an interface. The access node, in some embodiments, may be an eNB (evolved NodeB).

At least one of the PROGs 218, 228 is assumed to include program instructions that, when executed by the associated DP, enable the device to operate in accordance with exemplary embodiments of this invention, as will be discussed below in greater detail. That is, various exemplary embodiments of this invention may be implemented at least in part by computer software executable by the DP 214 of the device; and/or by the DP 224 of the access node, or by hardware, or by a combination of software and hardware (and firmware).

In general, the various embodiments of the device can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 216, 226 may be of any type suitable to the local technical environment and may be implemented using any suitable data storage technology, such as semiconductor based memory devices, flash memory, magnetic memory devices and systems, optical memory devices and systems, fixed memory and removable memory. The DPs 214, 224 may be of any type suitable to the local technical environment, and may include one or more of general purpose computers, special purpose computers, microprocessors, digital signal processors (DSPs) and processors based on a multicore processor architecture, as non-limiting examples. The wireless interfaces (e.g., RF transceivers 212 and 222) may be of any type suitable to the local technical environment and may be implemented using any suitable communication technology such as individual transmitters, receivers, transceivers or a combination of such components.

As a description of an example, the computer 16 will be used as being in communication with the access node 12. Features are equally applicable to any of the other stations (STAs). According to an example embodiment, there may be two categories of stations (STAs); a traffic indication map (TIM) STA and a non-TIM STA. TIM STAs may be required to decode long and/or short beacons for indication of presence of their buffered downlink data at the access point (AP). This may be an IEEE 802.11 network for example. Features as described herein may be used with wireless technologies other than IEEE 802.11, such as 3GPP based technologies for example. The carrier sensing mechanisms of the network 10 are defined in order to restrict transmissions while a STA (12, 14, 15 or 16) is currently transmitting. In general, a STA's state may be in any one mode at a particular time, either in receive (Rx) mode or in transmit (Tx) mode, and not in both mode at the same time. In an example embodiment, the network 10 may use more than one virtual carrier sensing mechanism, namely NAV (Network Allocation Vector) and RID (Response Indication Deferral). However, in an alternate example more than two virtual carrier sensing mechanisms could be used. In another example embodiment, only one virtual carrier sensing mechanism could be used. The devices 12, 14, 15, 16 may have NAV counters 240, 241 and RID counters 242, 243 schematically illustrated in FIG. 2. Organizations are currently trying to agree on a specification for IEEE 802.11ah, but no final agreement has been reached yet. In some proposals for IEEE 802.11ah there are two counters, a NAV counter and a RID counter, both of which need to be zero to conclude that the medium is idle. Response Indication Deferral (RID) has been proposed for the IEEE 802.11ah standard as a second virtual sensing mechanism to the conventional NAV virtual carrier sensing mechanism. Features as described herein may be used with one or more any suitable type of virtual sensing mechanism; not necessarily only NAV and/or RID. Use of NAV and RID in this description is merely an example.

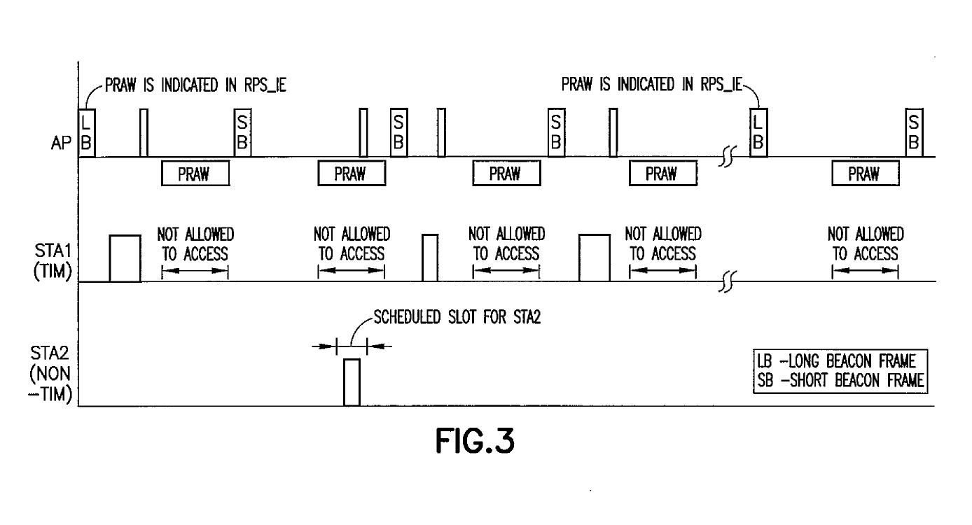

Referring also to FIG. 3, the example transmission from the access node 12 functioning as an access point (AP) may comprise two types of beacons: long beacons (LB) and short beacons (SB). The period between two LBs can vary from about 100 ms to 500 ms for example. There can be one or more SBs within the LB interval. In A TIM STA decodes long and short beacons for indication of presence of their buffered downlink data at the access point (AP).

A short beacon (SB) period is one or more of the following: a period from the long beacon (LB) to the first short beacon (SB) within the long beacons (LB) period, a period between to two consequent short beacons (SB) within the LB period, and a period from the last short beacons (SB) within the LB period to the next long beacon (LB).

A Restricted Access Window (RAW) is a group-based medium access where a group of STAs are allowed to access the medium for a specific duration. During this RAW duration STAs in other groups are prohibited from channel access. A RAW is a general term covering all RAW types. A Periodic RAW (PRAW) is a type of RAW which has periodical allocations and can be used to protect non-TIM STAs from TIM STAs. Another type of RAW is a Non-periodical Restricted Access Window (NRAW). In this example, two types of group reservations are provided for a SB period: Non-periodical Restricted Access Windows (NRAWs) can be used for a group of TIM STAs, and Periodic RAWs (PRAWs) can be used to protect non-TIM STAs from TIM STAs. In another example, zero or one type of group reservations may be provided for a SB period. Periodic RAW (PRAW) is mainly scheduled for non-TIM STAs such that their transmissions are protected from TIM STAs. NRAW and PRAW parameters are indicated in RAW Parameter Set (RPS) information element included in beacons and Probe Response frames. While RPS elements are included in almost every short beacon for TIM STA access information, full PRAW information is only included periodically in long beacons LB. The TIM STAs are prohibited from channel access during the scheduled PRAW periods.

NRAW allocations may vary between SB periods, but PRAW allocations are repeated similarly in every SB period. Therefore, NRAWs are scheduled in both LB and SB, whereas PRAWs are scheduled only in LB. A SB period may contain 0 or more NRAWs, and 0 or more PRAWs.

Within a SB period, both TIM STAs and non-TIM STAs may contend during non-reserved periods. However, TIM STAs may not contend during a PRAW period. If a TIM STA does not decode a long beacon LB correctly, or if the TIM STA wakes/associates after the LB transmission, without features as described herein, the TIM STA does not know whether there is some slot during a SB period in which it may contend. This is because, without features as described herein, the TIM STA would not be able to know, based on the SB, whether the SB period contains PRAW allocation or not. Thus, without features as described herein, the TIM STA would need to wait until the next LB. This may lead to unnecessary delay and non-efficient spectrum usage.

TIM STAs that are not indicated in the RAW Group are prohibited from channel access during the RAW durations. The TIM STAs are also prohibited from channel access during the PRAW periods as indicated in the FIG. 3. As shown in the FIG. 3, PRAW schedule indications are done in long beacons; not in short beacons. STA 1 in FIG. 3, such as 16 being a TIM STA, is prohibited while STA 2, such as 15 being a non-TIM STA, is allowed to access PRAW period. If a TIM STA is unable to decode a long beacon for any reason, it is now unaware of the PRAW schedules during a short beacon interval. In the FIG. 3, STA 1 is assumed to have received the long beacon correctly.

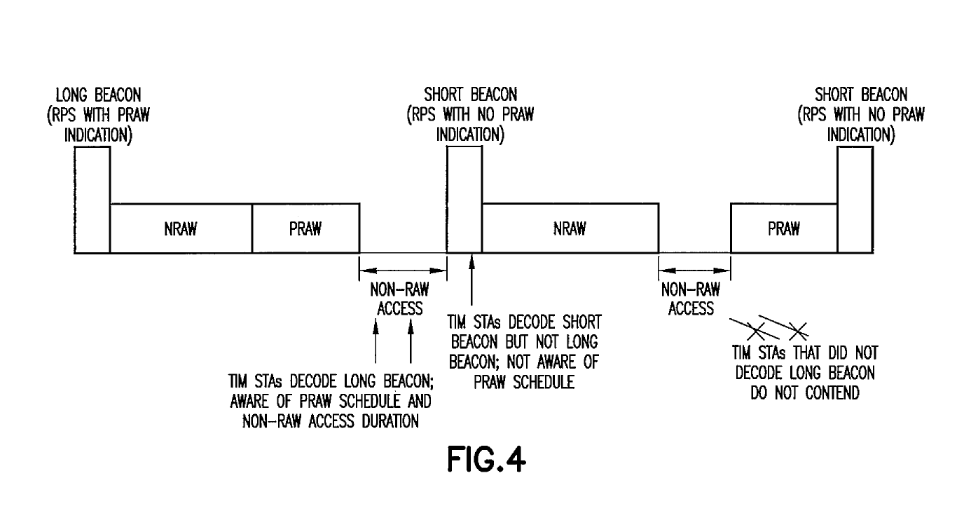

Referring also to FIG. 4, without features as described herein, in the case when a TIM STA did not decode the long beacon LB, but decoded a short beacon SB, and if it is not scheduled to access the NRAW duration, such as not within the NRAW Group for example, then within the short beacon interval the TIM STA would not be allowed within the NRAW duration. Since it is not sure about any PRAW schedule within this short beacon interval, it will be unable to transmit during the rest of the interval outside the RAW durations. In other words, based on the existing and proposed IEEE 802.11 standards, if TIM STAs are unable to decode the long beacon, they will be unable to access medium for long intervals; until they are part of one or more scheduled RAW Groups.

Getting information on all NRAWs and PRAWs would required getting detailed PRAW information in the SB. After that, the TIM STA could calculate non-RAW periods which can be used to contend channel access. However, providing information on PRAW allocation in each SB would require up to 9 bytes. Since, the PRAWs are periodical, adding this much information to SBs is considered too burdensome.

With features as described herein, in order to access the medium outside the NRAW and PRAW durations (non-RAW access), a STA may be made aware of the information about scheduled PRAW (start time and duration) and NRAW durations and their start times. Features as described herein provide a novel method of providing this information to the TIM STAs for non-RAW medium access. Features as described herein may be used to prevent prohibition of channel access of TIM STAs that have not received the long beacon correctly, or might have woken up after the long beacon transmission.

Technical Implementation

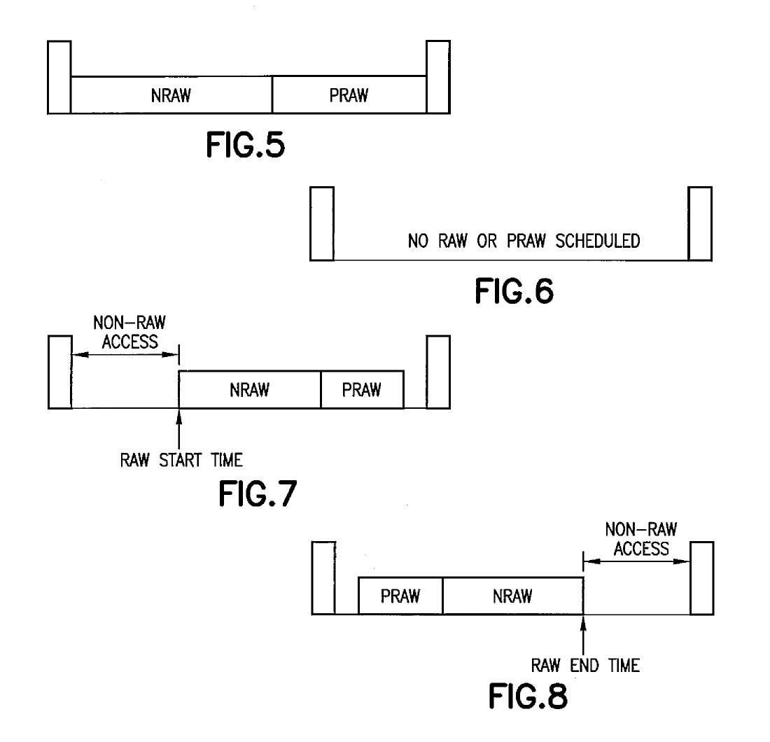

In one example embodiment two (2) bits are added to a short beacon SB to indicate a possible existence of a non-RAW slot. This may be used by a TIM STA that has missed the complete long beacon LB. This information may be included in the short beacon SB, especially in short beacon frames to enable the TIM STAs to contend for medium in non-RAW access intervals. An example of the two (2) bit indication is as follows:
00: The AP indicates that there is no schedule for non-RAW Access as indicated in FIG. 5.
01: The AP indicates that the entire beacon interval is allowed for non-RAW access as shown in FIG. 6.
10: The AP indicates that STAs can access the non-RAW interval from the end of beacon transmission to the beginning of NRAW Start Time (in RPS element) as shown in FIG. 7.
11: The AP indicates that STAs can access the non-RAW interval from the end of NRAW End Time (in RPS element) to the end of beacon interval as shown in FIG. 8.

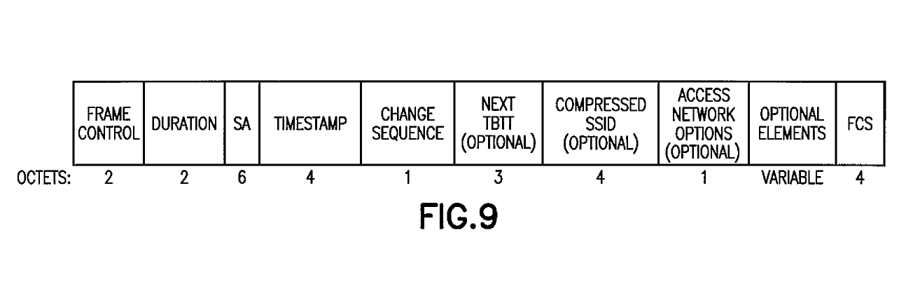

Referring also to FIG. 9 an example of a short beacon is shown. The two (2) bit indication may be included in the optional elements frame. The beacon shown in FIG. 9 is merely an example and should not be considered as limiting. One or more frames could be provided for the indication, and more or less than two (2) bits could be provided for the indication. Other details or specifics could be included with the indication. It may be desired to add some other information here and, thus, the result may be 3 or 4 bits instead of two.

The immediate advantage of this rule is to allow 802.11 TIM STAs to access medium in intervals outside the RAW durations and not within the scheduled PRAW periods. This also provides a method of energy savings for the TIM STAs. Features are fairly simple to implement; requiring only two (2) bits to allow a TIM STA to contend during a SB period in case it has missed a LB. The indication does not add the entire RAW assignment information of PRAW to the RPS element of SB, but instead uses a two bit indication, which indicates sufficient information for most use cases and thereby provides an advantage over trying to provide all the information in the short beacon SB.

In case a SB period contains more than one NRAW allocation or more than one PRAW, that may be a minor issue. However, most embodiments do not comprise multiple NRAWs or PRAWs within a single SB period. The non-presence of a RAW does not need to be indicated. The proposed solution provides a simple method to signal the presence of a PRAW either at the end or beginning of the beacon interval. It may put some restrictions on how PRAWs can be scheduled, but in an example embodiment the indication only requires 2 bits in a RPS element.

One may assume that, in most embodiments, the short beacon SB period has 0 or 1 NRAW and 0 or 1 PRAW. In a case there is both a NRAW and a PRAW, it is assumed that they are consecutive, or that a slot between them is not considered. In a case where only PRAW and no NRAW is scheduled, one may define a short RPS only indicating the RAW start time or RAW duration in addition to the two (2) bits. The RAW start time and Duration may be that of the PRAW.

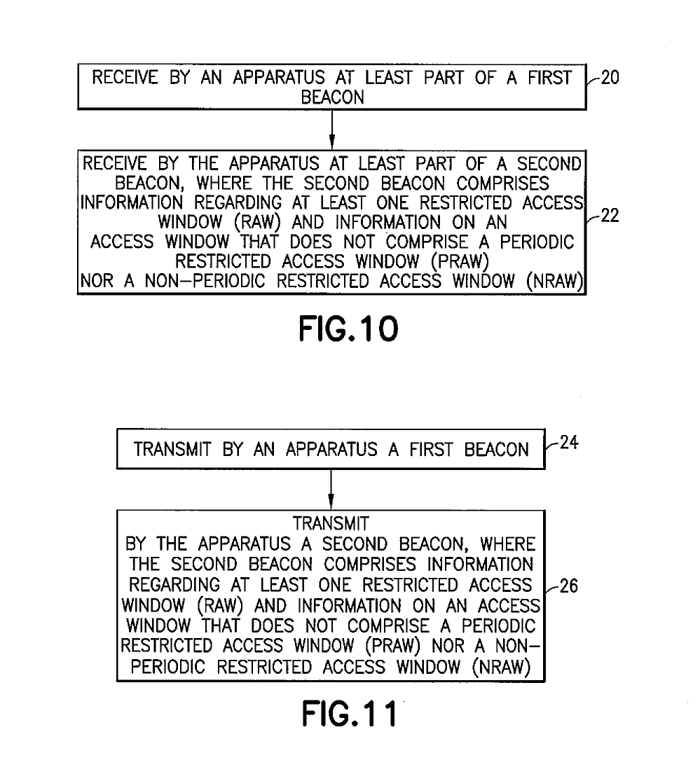

Referring also to FIG. 10, an example method may comprise receiving by an apparatus at least part of a first beacon as indicated by block 20, where the first beacon comprises information regarding at least a first periodic restricted access window (PRAW); and receiving by the apparatus at least part of a second beacon, where the second beacon comprises information regarding at least one restricted access window (RAW) and information on an access window that does not comprise a periodic restricted access window (PRAW) nor a non-periodic restricted access window (NRAW) as indicated by block 22, where the part of the second beacon received by the apparatus does not comprise complete information regarding a second periodic restricted access window (PRAW) of the second beacon. The information regarding at least one restricted access window (RAW) may comprise full information of NRAW or a subset of PRAW information in case the RAW. In case the the second beacon does not have any NRAW, the the information regarding at least one restricted access window (RAW) may need to comprise a subset of PRAW information to get its start time and end time values. The first beacon may be a long beacon and the second beacon may be a short beacon.

The first beacon may be larger than the second beacon. The first beacon may be a long beacon and the second beacon may be a short beacon. The information on the access window that does not comprise a periodic restricted access window (PRAW) nor a non-periodic restricted access window (NRAW) may comprise two bits which indicate at least one of no such access window, an entire beacon interval is available, a channel is available from an end of beacon transmission to the beginning of a RAW Start Time, the channel is available from the end of a RAW End Time to the end of a beacon interval. The apparatus may be a traffic indication map (TIM) station for a wireless local area network, and where the at least part of the first beacon and the second beacon are received from an access point. The first and the second periodic access windows may reserved for non-traffic indication map (non-TIM) stations. The apparatus may not be allowed to contend for medium access during any periodic restricted access window.

An example embodiment may be provided in an apparatus comprising at least one processor; and at least one non-transitory memory including computer program code, the at least one memory and the computer program code configured to, with the at least one processor, cause the apparatus at least to receive at least part of a first beacon, where the first beacon comprises information regarding at least a first periodic restricted access window (PRAW); and receive at least part of a second beacon, where the second beacon comprises information regarding at least one restricted access window (RAW) and information on an access window that does not comprise a periodic restricted access window (PRAW) nor a non-periodic restricted access window (NRAW), where the part of the second beacon received by the apparatus does not comprise complete information regarding a second periodic restricted access window (PRAW) of the second beacon.

An example embodiment may be provided in a non-transitory program storage device such as 216 and 218 for example readable by a machine, tangibly embodying a program of instructions executable by the machine for performing operations, the operations comprising receiving by an apparatus at least part of a first beacon, where the first beacon comprises information regarding at least a first periodic restricted access window (PRAW); and receiving by the apparatus at least part of a second beacon, where the second beacon comprises information regarding at least one restricted access window (RAW) and information on an access window that does not comprise a periodic restricted access window (PRAW) nor a non-periodic restricted access window (NRAW), where the part of the second beacon received by the apparatus does not comprise complete information regarding a second periodic restricted access window (PRAW) of the second beacon.

Referring also to FIG. 11, an example method may comprise transmitting by an apparatus a first beacon as indicated by block 24, where the first beacon comprises information regarding at least a first periodic restricted access window (PRAW); and transmitting by the apparatus a second beacon as indicated by block 26, where the second beacon comprises information regarding at least one restricted access window (RAW) and information on an access window that does not comprise a periodic restricted access window (PRAW) nor a non-periodic restricted access window (NRAW).

An example embodiment may be provided in an apparatus comprising at least one processor; and at least one non-transitory memory including computer program code, the at least one memory and the computer program code configured to, with the at least one processor, cause the apparatus at least to transmit by the apparatus a first beacon, where the first beacon comprises information regarding at least a first periodic restricted access window (PRAW); and transmit by the apparatus a second beacon, where the second beacon comprises information regarding at least one restricted access window (RAW) and information on an access window that does not comprise a periodic restricted access window (PRAW) nor a non-periodic restricted access window (NRAW).

An example embodiment may be provided in a non-transitory program storage device readable by a machine, tangibly embodying a program of instructions executable by the machine for performing operations, the operations comprising transmitting by the machine a first beacon, where the first beacon comprises information regarding at least a first periodic restricted access window (PRAW); and transmitting by the machine a second beacon, where the second beacon comprises information regarding at least one restricted access window (RAW) and information on an access window that does not comprise a periodic restricted access window (PRAW) nor a non-periodic restricted access window (NRAW).

Any combination of one or more computer readable medium(s) may be utilized as the memory. The computer readable medium may be a computer readable signal medium or a non-transitory computer readable storage medium. A non-transitory computer readable storage medium does not include propagating signals and may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

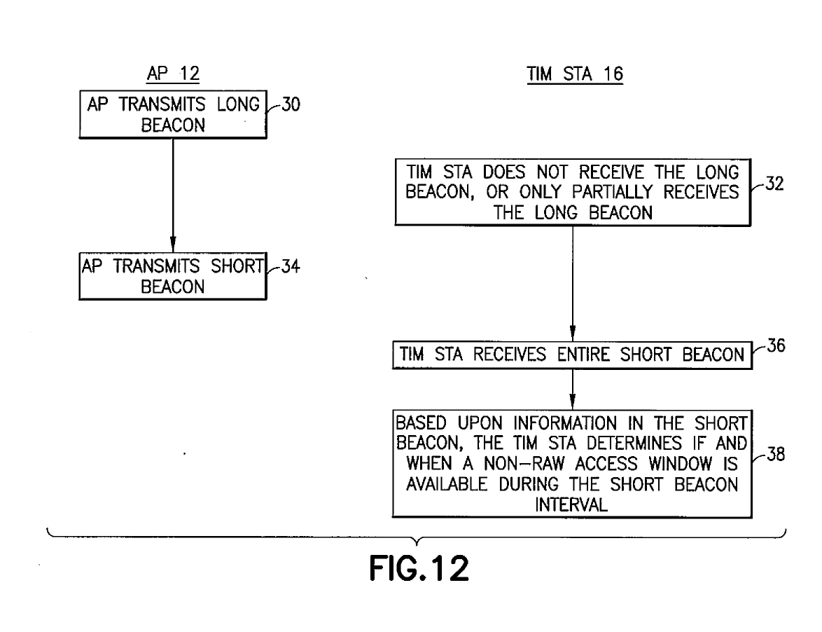

Referring also to FIG. 12, in an example method the AP may transmit a long beacon as indicated by block 30, and the TIM STA does not receive the ling beacon, or only partially receives the long beacon as indicated by block 32. The AP then subsequently transmits a short beacon as indicated by block 34, where the short beacon comprises the two (2) bit information noted above (as well as the other short beacon information). The TIM STA receives the short beacon as indicated by block 36 and, as indicated by block 38, the TIM STA is able to use the information to determine if and when a Non-RAW access window is available during the short beacon interval, such as non-RAW access windows shown in FIGS. 6, 7 and 8 for example.

An example embodiment may be provided in an apparatus comprising means for receiving by an apparatus at least part of a first beacon, where the first beacon comprises information regarding at least a first periodic restricted access window (PRAW); and means for receiving by the apparatus at least part of a second beacon, where the second beacon comprises information regarding at least one restricted access window (RAW) and information on an access window that does not comprise any restricted access window, where the part of the second beacon received by the apparatus does not comprise complete information regarding a second periodic restricted access window (PRAW) of the second beacon.

An example embodiment may be provided in an apparatus comprising means for transmitting by an apparatus a first beacon, where the first beacon comprises information regarding at least a first periodic restricted access window (PRAW); and means for transmitting by the apparatus a second beacon, where the second beacon comprises information regarding at least one restricted access window (RAW) and information on an access window that does not comprise any restricted access window.

An example method may comprise receiving by an apparatus a first beacon frame comprising complete information on at least a first periodic restricted access window; and receiving by the apparatus a second beacon frame comprising information on at least one restricted access window and information on an access window that does not comprise any restricted access window, wherein the second beacon frame does not comprise complete information on a second periodic restricted access window of a beacon period corresponding to the second beacon frame. The TIM STA may receive the long beacon (first beacon frame) getting all information on periodic RAW. Then the TIM STA might miss another long beacon and receives a short beacon (second beacon frame), and that short beacon would not comprise complete information on the PRAW, but indicates an access window part that is free from non-periodic and periodic RAWs. The first beacon frame may be larger than the second beacon frame. The first beacon frame may be a long beacon and the second beacon frame may be a short beacon. The information on the access window that does not comprise any restricted access window may comprise two bits which can be used to indicate at least one of the following: no such access window, the entire beacon interval is available, the channel is available from the end of beacon transmission to the beginning of RAW Start Time, the channel is available from the end of RAW End Time to the end of beacon interval. The apparatus may be a traffic indication map station for a wireless local area network, and the first beacon frame and the second beacon frame may be received from an access point. The first and the second periodic access windows may be reserved for non-TIM stations. The apparatus may not be allowed to contend for medium access during any periodic restricted access window.

An example method may comprise receiving by an apparatus a beacon, where the beacon comprises information regarding a restricted access window (RAW); and receiving in the beacon information regarding a non-restricted access window, where the non-restricted access window does not comprise the non-periodic restricted access window (NRAW) and does not comprise a periodic restricted access window (PRAW), where the information comprises only partial information regarding the periodic restricted access window (PRAW) or indicates absence of the periodic restricted access window (PRAW) during a beacon interval.

The beacon may be a second beacon and the method further comprises receiving by the apparatus at least part of a first beacon before the second beacon, where the first beacon comprises information regarding at least a first periodic restricted access window (PRAW), where the first beacon is larger than the second beacon. The beacon may be a second beacon and the method further comprises receiving by the apparatus at least part of a first beacon before the second beacon, where the first beacon is a long beacon and the second beacon is a short beacon. The information comprises two bits which indicate at least one of no such access window, an entire beacon interval is available, a channel is available from an end of beacon transmission to the beginning of a RAW Start Time, the channel is available from the end of a RAW End Time to the end of a beacon interval. The apparatus may be a traffic indication map (TIM) station for a wireless local area network, where the beacon is a second beacon and the method further comprises receiving by the apparatus at least part of a first beacon before the second beacon, and where the at least part of the first beacon and the second beacon are received from an access point. The periodic restricted access window (PRAW) may be reserved for non-traffic indication map (non-TIM) stations. The apparatus may be prevented to contend for medium access during any periodic restricted access window (PRAW).

An example embodiment may be provided in an apparatus comprising at least one processor; and at least one non-transitory memory including computer program code, the at least one memory and the computer program code configured to, with the at least one processor, cause the apparatus at least to receive by the apparatus a beacon, where the beacon comprises information regarding a restricted access window (RAW); and receive in the beacon information regarding a non-restricted access window, where the non-restricted access window does not comprise a non-periodic restricted access window (NRAW) and does not comprise a periodic restricted access window (PRAW), where the information comprises only partial information regarding the periodic restricted access window (PRAW) or indicates absence of the periodic restricted access window (PRAW) during a beacon interval.

An example embodiment may be provided in a non-transitory program storage device readable by a machine, tangibly embodying a program of instructions executable by the machine for performing operations, the operations comprising receiving by an apparatus a beacon, where the beacon comprises information regarding a restricted access window (RAW); and receiving in the beacon information regarding a non-restricted access window, where the non-restricted access window does not comprise a non-periodic restricted access window (NRAW) and does not comprise a periodic restricted access window (PRAW), where the information comprises only partial information regarding the periodic restricted access window (PRAW) or indicates absence of the periodic restricted access window (PRAW) during a beacon interval.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. A method comprising:
receiving by an apparatus at least part of a first beacon, where the first beacon comprises information regarding at least a first periodic restricted access window (PRAW); and
receiving by the apparatus at least part of a second beacon, where the second beacon comprises information regarding at least one restricted access window (RAW) and information on an access window that does not comprise a periodic restricted access window (PRAW) nor a non-periodic restricted access window (NRAW), where the part of the second beacon received by the apparatus does not comprise complete information regarding a second periodic restricted access window (PRAW) of the second beacon.

2. A method as in claim 1 where the first beacon is larger than the second beacon.

3. A method as in claim 1 where the first beacon is a long beacon and the second beacon is a short beacon.

4. A method as in claim 1 where the information on the access window that does not comprise a periodic restricted access window (PRAW) nor a non-periodic restricted access window (NRAW) comprises two to four bits which indicate at least one of:
no such access window,
an entire beacon interval is available,
a channel is available from an end of beacon transmission to the beginning of a RAW Start Time,
the channel is available from the end of a RAW End Time to the end of a beacon interval.

5. A method as in claim 1 where the apparatus is a traffic indication map (TIM) station for a wireless local area network, and where the at least part of the first beacon and the second beacon are received from an access point.

6. A method as in claim 1 where the first and the second periodic restricted access windows are reserved for non-traffic indication map stations.

7. A method as in claim 1 where the apparatus is not allowed to contend for medium access during any periodic restricted access window.

8. An apparatus comprising
at least one processor; and
at least one non-transitory memory including computer program code,
the at least one memory and the computer program code configured to, with the at least one processor, cause the apparatus at least to:
receive at least part of a first beacon, where the first beacon comprises information regarding at least a first periodic restricted access window (PRAW); and
receive at least part of a second beacon, where the second beacon comprises information regarding at least one restricted access window (RAW) and information on an access window that does not comprise a periodic restricted access window (PRAW) nor a non-periodic restricted access window (NRAW), where the part of the second beacon received by the apparatus does not comprise complete information regarding a second periodic restricted access window (PRAW) of the second beacon.

9. A non-transitory program storage device readable by a machine, tangibly embodying a program of instructions executable by the machine for performing operations, the operations comprising:
receiving by an apparatus at least part of a first beacon, where the first beacon comprises information regarding at least a first periodic restricted access window (PRAW); and
receiving by the apparatus at least part of a second beacon, where the second beacon comprises information regarding at least one restricted access window (RAW) and information on an access window that does not comprise a periodic restricted access window (PRAW) nor a non-periodic restricted access window (NRAW), where the part of the second beacon received by the apparatus does not comprise complete information regarding a second periodic restricted access window (PRAW) of the second beacon.

10. A method comprising:
transmitting by an apparatus a first beacon, where the first beacon comprises information regarding at least a first periodic restricted access window (PRAW); and
transmitting by the apparatus a second beacon, where the second beacon comprises information regarding an access window that comprises neither a periodic restricted access window (PRAW) nor a non-periodic restricted access window (NRAW).

11. A method as in claim 10 where the first beacon is larger than the second beacon.

12. A method as in claim 10 where the first beacon is a long beacon and the second beacon is a short beacon.

13. A method as in claim 10 where the information on the access window that does not comprise a periodic restricted access window (PRAW) nor a non-periodic restricted access window (NRAW) comprises two to four bits which indicate at least one of:
no such access window,
an entire beacon interval is available,
a channel is available from an end of beacon transmission to the beginning of a RAW Start Time,
the channel is available from the end of a RAW End Time to the end of a beacon interval.

14. A method as in claim 10 where the apparatus is a traffic indication map (TIM) station for a wireless local area network, and where the at least part of the first beacon and the second beacon are received from an access point.

15. A method as in claim 10 where the first and the second periodic access windows are reserved for non-traffic indication map stations.

16. A method as in claim 10 where the apparatus is not allowed to contend for medium access during any periodic restricted access window.

17. An apparatus comprising:
at least one processor; and
at least one non-transitory memory including computer program code,
the at least one memory and the computer program code configured to, with the at least one processor, cause the apparatus at least to:
transmit by the apparatus a first beacon, where the first beacon comprises information regarding at least a first periodic restricted access window (DRAW); and
transmit by the apparatus a second beacon, where the second beacon comprises information regarding an access window that does not comprise either a periodic restricted access window (PRAW) or a non-periodic restricted access window (NRAW).

18. A non-transitory program storage device readable by a machine, tangibly embodying a program of instructions executable by the machine for performing operations, the operations comprising:
transmitting by the machine a first beacon, where the first beacon comprises information regarding at least a first periodic restricted access window (PRAW); and
transmitting by the machine a second beacon, where the second beacon comprises information regarding an access window that does not comprise either a periodic restricted access window (PRAW) or a non-periodic restricted access window (NRAW).
